(19) United States
(12) Patent Application Publication
(10) Pub. No.: US 2006/0080108 A1
(43) Pub. Date: Apr. 13, 2006

(54) Sound effect processing circuit

(75) Inventor: Tai-Chi Liu, Pingzhen City (TW)

Correspondence Address: BRUCE H. TROXELL, SUITE 1404, 5205 LEESBURG PIKE, FALLS CHURCH, VA, 22041, US

(73) Assignee: ULi Electronics Inc.

(21) Appl. No.: 11/074,625

(22) Filed: Mar. 9, 2005

(30) Foreign Application Priority Data
Oct. 12, 2004 (TW) 93130803

(51) Int. Cl. G10L 21/00

(52) U.S. Cl. 704/500

(57) ABSTRACT

The invention provides a sound effect processing circuit, in which a multiplexer is utilized to receive and switch the sound effect source, i.e. output digital signal of an IC chip, to a slot with a replaceable D/A decoder and a communication and networking riser. The D/A decoder in the slot can be changed and determined according to the standard of output digital signal of the IC chip. The sound effect processing circuit of the invention can thus replace D/A decoder in accordance with the standard of the sound effect source and is more compatible.

### FIELD OF THE INVENTION

The present invention relates to a sound effect processing circuit, more particularly to a sound effect processing circuit with a switch and a slot.

### BACKGROUND OF THE INVENTION

In the present main board structure, the part for sound effect processing is mainly implemented by a hardware circuit. This conventional sound effect processing circuit utilizes a fixed decoder, thus a situation of lacking compatibility occurs. For example, the sound effect processing part of the Intel's ICH6 chip is ACZ unit, wherein the ACZ unit can provide such as Azalia standard or AC97 standard.

In brief, ACZ unit can provide a sound effect output of 8 channels when ACZ unit provides Azalia standard and ACZ unit can provide a sound effect output of 5.1 channels when ACZ unit provides AC97 standard.

FIG. 1 is a diagram of a conventional sound effect processing circuit. In FIG. 1, ACZ unit 115 of an ICH6 chip 110 of a main board 100 matches with a sound effect processing circuit 120 which comprising a connecting bus 130 and a digital/analog decoder 140. The connecting bus 130 can transmit sound effect source, i.e. output digital signal of ACZ unit 115, to a communication and networking riser 150 or to the digital/analog decoder 140. After converting digital sound effect signal to analog sound effect signal by an insert card of the communication and networking riser 150 or the digital/analog decoder 140, analog sound effect signal will be output by a speaker output terminal (not shown) of the communication and networking riser 150 or output by a speaker output terminal 170 via a connecting bus 160.

However, the sound effect processing circuit 120 is soldered on the main board 100 when manufacturing the main board 100. Thus, the digital/analog decoder 140 must be one capable of decoding Azalia standard if ACZ unit 115 provides Azalia standard and the digital/analog decoder 140 must be one capable of decoding AC97 standard if ACZ unit 115 provides AC97 standard.

Further, since the standard can be decoded by the digital/analog decoder 140 is limited, the card, such as a modem card, inserted in the communication and networking riser 150 must be one capable of supporting the same standard of the output sound effect decoded by the digital/analog decoder 140.

Therefore, in the condition of soldering the sound effect processing circuit 120 on the main board 100, the sound effect processing circuit 120 must be selected to match with ACZ unit 115 of the IC chip 110. Similarly, for the main board manufacturers, the digital/analog decoder 140 of the sound effect processing circuit 120 must be selected to match with ACZ unit 115 of the IC chip 110. In addition, the sound effect processing part of the card inserted in the communication and networking riser 150 is also limited when the standard can be decoded by the digital/analog decoder 140 is determined.

Based on those mentioned above, if the main board manufacturers want to raise the standard of output sound effect of the main board 100 by replacing the IC chip 110 only containing ACZ unit 115 with an IC chip containing a sound effect unit capable of outputting Azalia standard, the connecting bus 130 of the sound effect processing circuit 120 may not transmit digital signals of Azalia standard and the digital/analog decoder 140 can not decode digital signals of Azalia standard. Thus, the sound effect processing circuit 120 can not support sound effect outputs of Azalia standard and AC97 standard simultaneously.

To solve the above-mentioned problem, the invention provides a sound effect processing circuit capable of supporting sound effect units of more than one standard.

### SUMMARY OF THE INVENTION

The main objective of the present invention is to provide a sound effect processing circuit, which is capable of supporting sound effect units of more than one standard. For achieving the objective, the sound effect processing circuit of the present invention comprises a connecting bus, a multiplexer, a slot, and a digital/analog decoder, wherein the connecting bus transmits output digital signal of a sound effect device, the multiplexer receives, switches and outputs the digital signal transmitted by the bus, the slot receives the digital signal output by the multiplexer and processes the digital signal by a digital/analog decoder therein to output analog signal to a sound effect output terminal, and the digital/analog decoder converts the digital signal to analog signal.

In a preferred embodiment of the present invention, the sound effect device is a sound effect unit of an IC chip and is capable of supporting a standard of multiple channels output, e.g. the sound effect device can be a sound effect unit supporting a standard of six channels output or a sound effect unit supporting a standard of eight channels output. To match with the above-mentioned sound effect unit, the digital/analog decoder in the slot must support a standard of six channels output or a standard of eight channels output. The sound effect output terminal can also support a standard of six channels output and a standard of eight channels output simultaneously.

Similarly, to achieve the above-mentioned objective, the present invention provides another sound effect processing circuit comprising two connecting buses, a multiplexer, a slot, and a digital/analog decoder, wherein the two connecting buses transmit output digital signals of two sound effect devices, respectively.

In another preferred embodiment of the present invention, the sound effect devices are a first sound effect unit and a second sound effect unit of an IC chip and, for example, are capable of supporting a standard of six channels output and a standard of eight channels output, respectively. On the other hand, the sound effect devices can be a first sound effect unit and a second sound effect unit of an IC chip and these two sound effect units are both capable of supporting a standard of six channels output. The digital/analog decoder in the slot can decode a standard of multiple channels output, e.g. a standard of six channels output or a standard of eight channels output. The sound effect output terminal can also support a standard of six channels output and a standard of eight channels output simultaneously.

To make the examiner easier to understand the objective, structure, innovative features, and function of the invention, preferred embodiments together with accompanying drawings are illustrated for the detailed description of the invention.

### BRIEF DESCRIPTION OF THE DRAWINGS

FIG. 1 is a diagram of a conventional sound effect processing circuit.

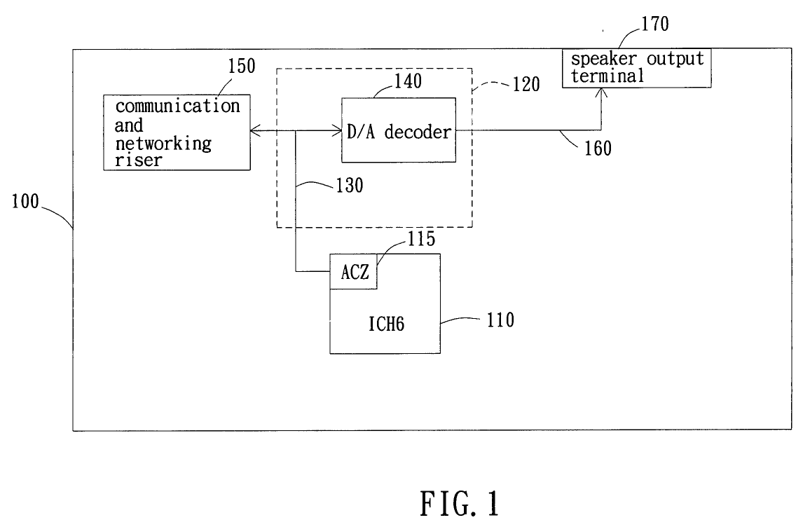

FIG. 2 is a diagram of a sound effect processing circuit of a preferred embodiment of the present invention.

FIG. 3 is a diagram of a sound effect processing circuit of another preferred embodiment of the present invention.

### DESCRIPTION OF THE PREFERRED EMBODIMENT

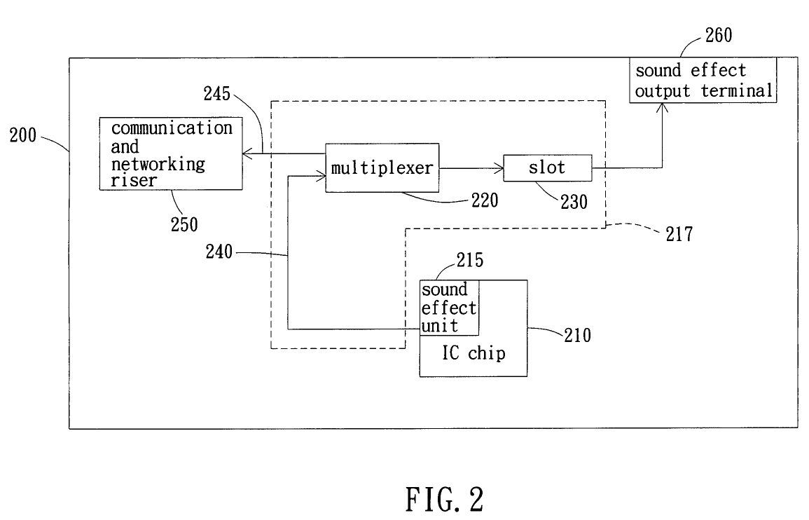

FIG. 2 is a diagram of a sound effect processing circuit of a preferred embodiment of the present invention. For matching with a sound effect unit 215, which supports AC97 standard of six channels output or Azalia standard of eight channels output, of an IC chip 210 on a main board 200, a sound effect processing circuit 217 of the present invention utilizes a multiplexer 220 and a slot 230 containing a digital/analog decoder (not shown) to raise compatibility for different sound effect units.

In FIG. 2, the multiplexer 220 can receive the output digital signal of the sound effect unit 215 of the IC chip 210 via the connecting bus 240 and switch the output digital signal via the connecting bus 245 to, for example, a modem card inserted in a communication and networking riser 250. Further, the standard of multiple channels output provided by the sound effect unit 215 can be matched by changing a digital/analog decoder (not shown) in the slot 230, e.g. a digital/analog decoder capable of decoding a standard of eight channels output or a digital/analog decoder capable of decoding a standard of six channels output. That is, a digital/analog decoder capable of decoding a standard of eight channels output will be inserted if output digital signal of the sound effect unit 215 is a standard of eight channels output, and a digital/analog decoder capable of decoding a standard of six channels output will be inserted if output digital signal of the sound effect unit 215 is a standard of six channels output.

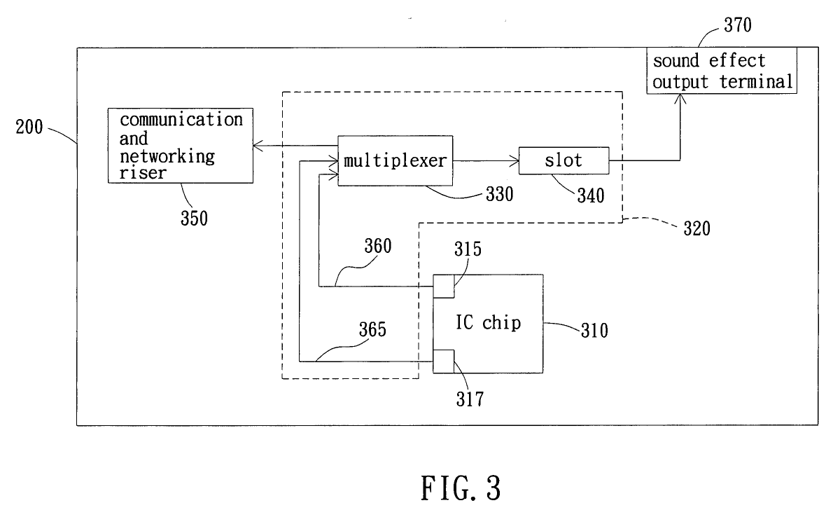

FIG. 3 is a diagram of a sound effect processing circuit of another preferred embodiment of the present invention. In FIG. 3, the IC chip 210 comprising one sound effect unit 215 in FIG. 2 is changed to an IC chip 310 comprising two sound effect units 315 and 317, and a sound effect processing circuit 320 comprises a multiplexer 330 and a slot 340. For matching with the two sound effect units 315 and 317, the sound effect processing circuit 320 utilizes two connecting buses 360 and 365 to transmit output digital signals of the two sound effect units 315 and 317, respectively, to the multiplexer 330. The multiplexer 330 then switches the digital signals to the slot 340 or to a communication and networking riser 350. Further, a digital/analog decoder (not shown) inserted in the slot 340 is selected and determined according to the standards of multiple channels output digital signals of the sound effect units 315 and 317 in the IC chip 310. For example, a user can determine to select which kind of digital/analog decoder based on his own needs when the sound effect unit 315 provides a standard of eight channels output digital signal and the effect unit 317 provides a standard of six channels output digital signal.

Therefore, no matter what kind of the standards of multiple channels output the sound effect units provide, especially when the IC chip on the main board is changed to one containing different sound effect units, the sound effect processing circuit of the present invention utilizes a switching multiplexer and a matching digital/analog decoder inserted in a slot to match therewith. By those mentioned above, the sound effect processing circuit of the present invention is more compatible than the conventional technique, which can not support the main board with an IC chip containing different types of sound effect units because of the limitation that the sound effect processing circuit is soldered on the main board, when the IC chip on the main board is changed to one containing different types of sound effect units.

To sum up, the present invention provides a sound effect processing circuit, in which a multiplexer is utilized to receive and switch the sound effect source, i.e. output digital signal of an IC chip, to a slot with a replaceable D/A decoder and a communication and networking riser. The D/A decoder in the slot can be changed and determined according to the standard of output digital signal of the IC chip. The sound effect processing circuit of the present invention can thus replace the D/A decoder in accordance with the standard of the sound effect source and is more compatible.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A sound effect processing circuit, comprising:
a connecting bus for transmitting output digital signal of a sound effect device;
a multiplexer for receiving and switching out the digital signal transmitted by the connecting bus; and
a slot for receiving and processing the digital signal switched out by the multiplexer and outputting an analog signal to a sound effect output terminal, wherein the slot contains a digital/analog decoder for converting the digital signal to the analog signal.

2. The sound effect processing circuit of claim 1, wherein the sound effect device is a sound effect unit of an IC chip and the sound effect unit is capable of supporting a standard of multiple channels output.

3. The sound effect processing circuit of claim 1, wherein the sound effect unit is capable of supporting a standard of six channels output.

4. The sound effect processing circuit of claim 1, wherein the sound effect unit is capable of supporting a standard of eight channels output.

5. The sound effect processing circuit of claim 1, wherein the digital/analog decoder is capable of decoding a standard of multiple channels output digital signal.

6. The sound effect processing circuit of claim 1, wherein the digital/analog decoder is capable of decoding a standard of six channels output digital signal.

7. The sound effect processing circuit of claim 1, wherein the digital/analog decoder is capable of decoding a standard of eight channels output digital signal.

8. The sound effect processing circuit of claim 1, wherein the sound effect output terminal is capable of supporting the standards of six channels output digital signal and eight channels output digital signal simultaneously.

9. A sound effect processing circuit, comprising:
two connecting buses for respectively transmitting output digital signals of two sound effect devices;
a multiplexer for receiving and switching out the digital signals transmitted by the connecting buses; and
a slot for receiving and processing the digital signals switched out by the multiplexer and outputting analog signals to a sound effect output terminal, wherein the slot contains a digital/analog decoder for converting the digital signals to the analog signals.

10. The sound effect processing circuit of claim 9, wherein the two sound effect devices are a first sound effect unit and a second sound effect unit of an IC chip and the first sound effect unit and the second sound effect unit are respectively capable of supporting a standard of six channels output and a standard of eight channels output.

11. The sound effect processing circuit of claim 9, wherein the two sound effect devices are a first sound effect unit and a second sound effect unit of an IC chip and the first sound effect unit and the second sound effect unit are both capable of supporting a standard of six channels output.

12. The sound effect processing circuit of claim 9, wherein the digital/analog decoder is capable of decoding a standard of multiple channels output digital signal.

13. The sound effect processing circuit of claim 9, wherein the digital/analog decoder is capable of decoding a standard of six channels output digital signal.

14. The sound effect processing circuit of claim 9, wherein the digital/analog decoder is capable of decoding a standard of eight channels output digital signal.

15. The sound effect processing circuit of claim 9, wherein the sound effect output terminal is capable of supporting the standards of six channels output digital signal and eight channels output digital signal simultaneously.
